(19) United States
(12) Patent Application Publication
(10) Pub. No.: US 2025/0316024 A1
(43) Pub. Date: Oct. 9, 2025

(54) Decoding Face Gestures from Human Speech and Other Sounds for Avatar Rendering in AR/VR Applications

(71) Applicant: Apple Inc., Cupertino, CA (US)

(72) Inventors: Miquel Espi Marques, Cupertino, CA (US); Brian Amberg, Zollikon (CH); Carlos M. Avendano, Campbell, CA (US); Kevin M. Durand, San Francisco, CA (US); Vasudha Kowtha, San Francisco, CA (US)

(21) Appl. No.: 19/173,484

(22) Filed: Apr. 8, 2025

Related U.S. Application Data
(60) Provisional application No. 63/631,772, filed on Apr. 9, 2024.

(51) Int. Cl. G06T 17/10

(52) U.S. Cl. CPC G06T 17/10

(57) ABSTRACT

Generating a persona includes capturing, for each of a plurality of frames, sensor data that includes image and audio of a subject. Image and audio data are captured of the subject. First geometric data representing the subject is generated using the image data. Second geometric data representing the subject is determined using the first geometric data and a characteristics of the subject from the audio data, wherein the second geometric data is different than the first geometric data. A 3D geometric representation of the subject for a subject persona is generated using the second geometric data.

### BACKGROUND

Computerized characters that represent and are controlled by users are commonly referred to as avatars. Avatars may take a wide variety of forms including virtual humans, animals, and plant life. Some computer products include avatars with facial expressions that are driven by a user's facial expressions. One use of facially-based avatars is in communication, where a camera and microphone in a first device transmits audio and a real-time 2D or 3D avatar of a first user to one or more second users such as other mobile devices, desktop computers, videoconferencing systems, and the like. Known existing systems tend to be computationally intensive, requiring high-performance general and graphics processors, and generally do not work well on mobile devices, such as smartphones or computing tablets. Further, improvements are needed regarding the ability to communicate nuanced facial representations or emotional states in a realistic manner during runtime.

### BRIEF DESCRIPTION OF THE DRAWINGS

FIG. 1 shows a simplified flow diagram for generating a target 3D representation of a subject, according to one or more embodiments.

FIGS. 2A-2B show flowcharts of example techniques for using visual and audio data for generating a 3D representation of a subject, according to one or more embodiments.

FIG. 3 shows, in flow diagram form, a technique for generating a geometric representation of a subject during runtime, according to one or more embodiments.

FIG. 4 shows, in flow diagram form, an enrollment technique, in accordance with one or more embodiments.

FIG. 5 shows, in block diagram form, a multi-function electronic device in accordance with one or more embodiments.

FIG. 6 shows, in block diagram form, a computer system in accordance with one or more embodiments.

### DETAILED DESCRIPTION

This disclosure relates generally to image processing. More particularly, but not by way of limitation, this disclosure relates to techniques and systems for generating photorealistic representations of subjects using visual and audio data.

This disclosure pertains to systems, methods, and computer readable media to generating 3D information of a face using visual and audio sensor data of a subject. When a user is using a system, such as a head-mounted device, to drive a virtual representation of the user, the user's face may be covered by the device, and/or the device may restrict user's facial movements such that the sensor data captured of the user may be incomplete, or may not match the user's emotions and/or accurate facial expression had the face been unimpeded by the device. Accordingly, techniques described herein use image data and/or depth data captured by the system, as well as audio data concurrently captured with the movements. The audio data can thereafter supplement or modify the geometric information of the user's expression, thereby allowing the system to generate a representation of the user that better matches the expression the user would have made had the user's movements not been impeded by the system.

According to one or more embodiments, image and audio are captured of a subject. First geometric data is determined for the subject using the image. A characteristic of the subject is determined from the audio, and second geometric data for the subject is determined using the first geometric data and the characteristic of the subject. A 3D geometric representation of the subject for a subject persona is generated using the second geometric data.

In some embodiments, the geometric information can be obtained in the form of latents. For example, an expression autoencoder may be trained to reduce a particular expression to a set of geometric latents which represents a geometry of an expressive face based on image data and/or depth data. Further, in one or more embodiments, an audio autoencoder may be configured to generate audio latents based on audio data captured of the subject and/or the subject's environment. The audio latents may further be mapped to expression data, such as additional geometric latents. Alternatively, the audio latents may be mapped to weights or other parameters to be applied to the geometric latents generated by the expression encoder. A decoder can then take the revised or augmented geometric latents to generate a 3D representation of the expression of the subject.

For purposes of this disclosure, an autoencoder refers to a type of artificial neural network used to fit data in an unsupervised manner. The aim of an autoencoder is to learn a representation for a set of data in an optimized form. An autoencoder is designed to reproduce its input values as outputs, while passing through an information bottleneck that allows the dataset to be described by a set of latent variables. The set of latent variables are a condensed representation of the input content, from which the output content may be generated by the decoder. A trained autoencoder will have an encoder portion, a decoder portion, and the latent variables represent the optimized representation of the data.

For purposes of this disclosure, the term “persona” refers to a photorealistic virtual representation of a real-world subject, such as a person, animal, plant, object, and the like. The real-world subject may have a static shape, or may have a shape that changes in response to movement or stimuli.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly- or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes, and may not have been selected to delineate or circumscribe the inventive subject matter, and the claims may be necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of graphics modeling systems having the benefit of this disclosure.

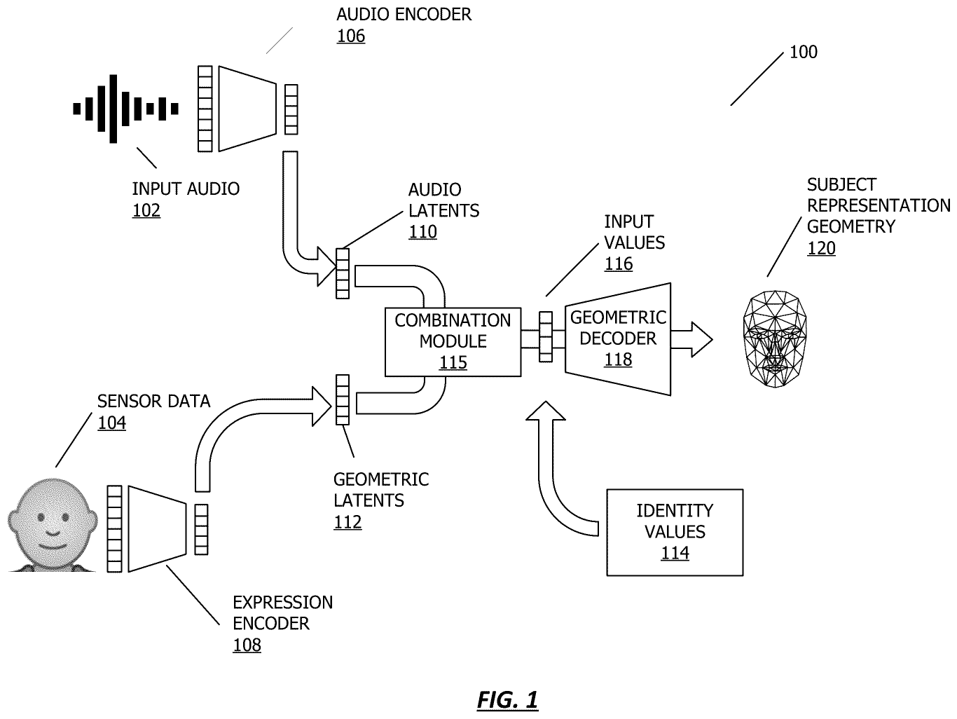

Referring to FIG. 1, a flow diagram 100 is depicted in which audio data and other sensor data are used to generate a geometry of a subject representative, according to one or more embodiments. The example flow is presented merely for description purposes. In one or more embodiments, not all components detailed may be necessary, and in one or more embodiments additional or alternative components may be utilized.

Initially, input audio 102 and sensor data 104 are received of a subject. The sensor data 104 may include image data and/or depth data captured of a subject. In some embodiments, the sensor data is captured by a device worn by the user, for example by cameras, depth sensors, and the like, configured to capture sensor data of various portions of the subject's face and/or body while the subject is using the device. The sensor data 104 may include data from one or more different types of sensors. Input audio 102 may include audio collected from a subject while the sensor data 104 is collected. As such, input audio 102 may be collected by one or more microphones. In some embodiments, input audio 102 may be captured by one or more microphones of a device worn by the subject, such as the device having the one or more sensors capturing sensor data 104.

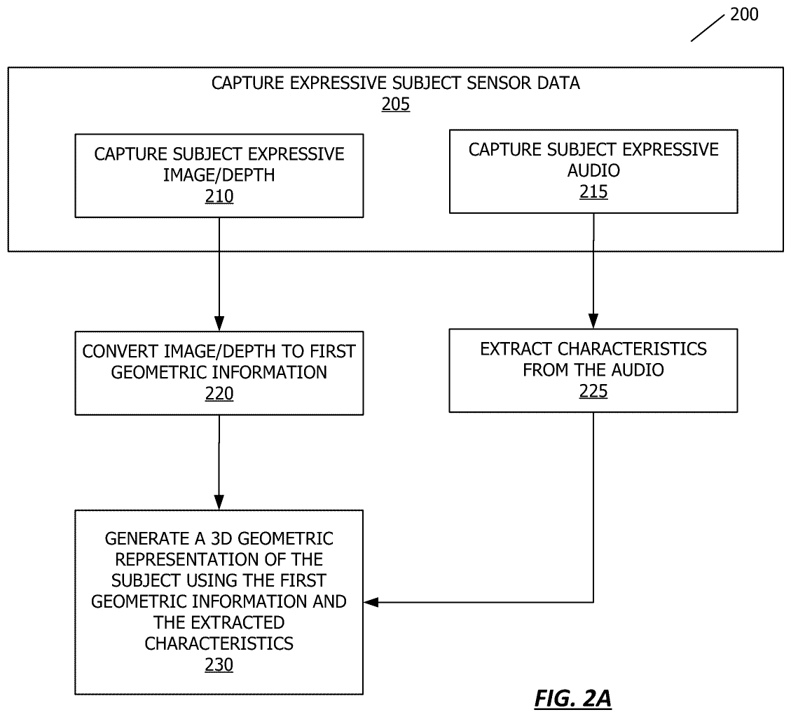

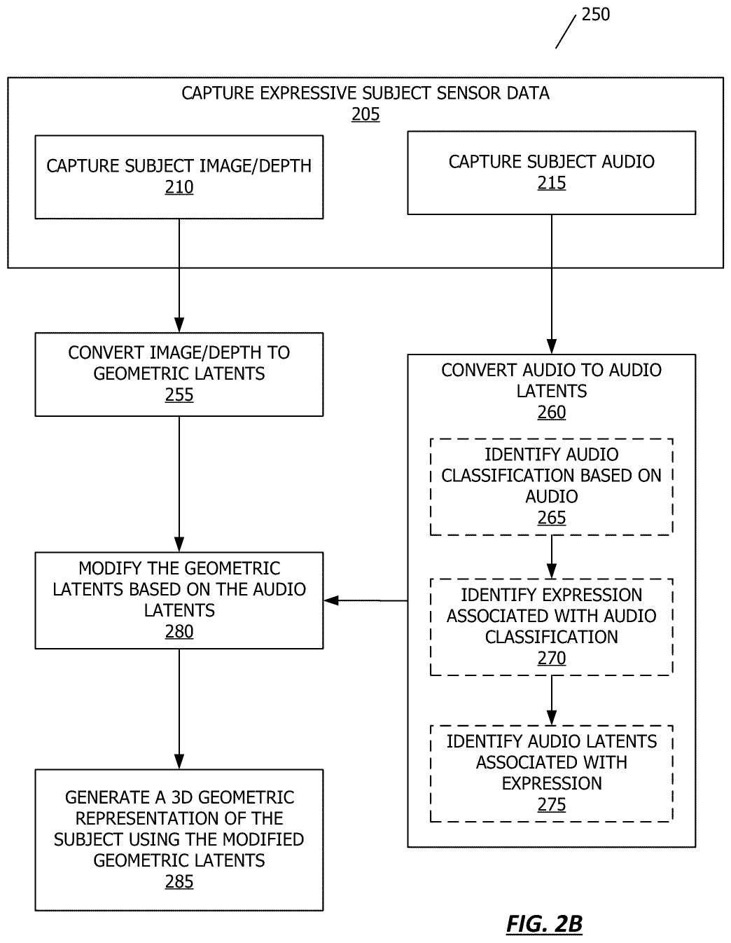

According to one or more embodiments, geometry information may be determined from a combination of the input audio 102 and the sensor data 104. This may be determined in a variety of ways, as will be described below with respect to FIG. 2A. For purposes of this example, the input audio 102 may be applied to an audio encoder 106, configured to generate audio latents 110 from the input audio 102. The audio encoder 106 may be an encoder portion of an audio autoencoder which has been configured to compress input audio 102 into latent variables. As such, the audio latents 110 may include a compressed representation of the input audio 102. In some embodiments, the audio latents 110 may be reflective of certain unique characteristics of the subject's voice/audible expression from audio 102. For instance, the audio latents 110 may be reflective of the emotion of the subject's voice.

Similarly, sensor data 104 may be used to determine geometric information, such as geometric latents 112. According to some embodiment, the flow diagram 100 includes an expression encoder 108 from an expression autoencoder which takes in image and/or depth information of facial expressions presented in the series of frames. The expression autoencoder may be trained to recreate a geometric representation of a subject's expressive face. Thus, as an initial step, the sensor data 104 may include image data that used to generate a 3D representation of the subject geometry. The sensor data 104 may be collected from one or more sensors, and may include one or more different types of sensor data. For example, different sensors may capture characteristics of different parts of a subject's face. As an example, in a head-mounted device, one camera may capture a left mouth region of the subject, while another camera may capture a right mouth region of the subject. The various sensor data may be used to generate the 3D representation, for example in the form of a 3D mesh. As an example, an expression neural network model may be used which maps expressive image data to a 3D geometry of a representation of the expression. In one or more embodiments, the expression autoencoder “compresses” the variables in the 3D geometry to a smaller number of geometric latents 112 which may represent a geometry of the subject. In some embodiments, the geometric latents 112 may represent a geometric offset from a subject's neutral face or otherwise represent a geometric representation of a face for a given expression.

In some embodiments, a geometric decoder 118 may use input values 116 to generate a subject representation geometry 120. The input values may include a combination of the audio latents 110 (or other representation of the input audio 102), and the geometric latents 112 (or other representation of the geometry from the sensor data 104). In some embodiments, identify values 114 may additionally be considered. Identity values 114 may indicate a uniqueness of an individual, such as how a particular expression or emotion uniquely affects a geometry of the face, or other characteristics of the face. In some embodiments, identity values 114 may include information for how the audio latents 110 and/or geometric latents 112 should be weighted or otherwise combined with each other.

In one or more embodiments, the various inputs may be weighted or calibrated against each other by a combination module 115 to obtain input values 116. As an example, the audio latents 110 may include 33 values, whereas the geometric latents may be an additional 28 values. The combined values may be normalized in order to prevent over-representation or under-representation of the various values. In one or more embodiments, batch normalization may be utilized to adjust or condense the various values of input values 116.

The resulting input values 116 may be applied to a geometric decoder 118. The geometric decoder may be a decoder portion of a geometric autoencoder which is trained to generate a 3D geometric representation of a subject. The geometric decoder 118 may be configured to ingest the combination of input values from the input audio 102 and other sensor data 104 to generate the subject representation geometry 120. The subject representation geometry 120 may then be used to render a virtual representation of the subject captured in sensor data 104 and input audio 102, for example in the form of a persona.

Because the subject representation geometry 120 is generated using the sensor data 104 as well as input audio 102, the subject representation geometry 120 may differ from a 3D geometry of a representation of the expression used as input into expression encoder 108. Further, the subject representation geometry may differ than the geometry represented by geometric latents 112. For example, the subject representation geometry 120 may capture facial movements which are intended by the subject and which would normally be produced by the subject if the subject's face were not restricted by the head mounted device. Accordingly, in some embodiments, the geometric data 112 from the sensor data 104 may effectively be modified by geometric decoder 118 based on the audio latents 110 to generate subject representation geometry 120.

It should be understood that the various processes of flow diagram 100 may be performed by one or more devices. For example, one or more devices may capture the input audio 102 and the sensor data 104. As another example, one device may perform the process described up until the input values 116 are generated. Then the input values may be transmitted to a remote device which applies the input values 116 to a geometric decoder 118 to generate the subject representation geometry 120, such that a resulting persona rendered using the subject representation geometry 120 can be displayed at the remote device.

In some embodiments, the subject representation geometry 120 can be generated by various combinations of characteristics from input audio 102 and sensor data 104. As an example, the audio latents 110 may be replaced by another kind of representation. As another example, the geometric latents 112 may be replaced by another compact representation of geometry of an expression that does not utilize an autoencoder.

FIG. 2A shows a flowchart of an example technique for using visual and audio data for generating a 3D representation of a subject, according to one or more embodiments. Although the various processes depicted in FIG. 2A are illustrated in a particular order, it should be understood that the various processes described may be performed in a different order. Further, not all of the various processes may be necessary to be performed.

The flowchart 200 begins at block 205, where sensor data is captured of a subject during runtime. Capturing sensor data may include, as shown at block 210, capturing expressive image data and/or depth data of a subject. As described above, the sensor data may be captured by a device worn by the subject, for example by a camera, depth sensor, and the like, configured to capture sensor data of various portions of the subject's face and/or body while the subject is using the device. The sensor data captured at 210 may include data from one or more different types of sensors, and may include one or more different types of sensor data. For example, different sensors may capture characteristics of different parts of a subject's face. As an example, in a head-mounted device, one camera may capture a left eye region of the subject, while another camera may capture a right eye region of the subject. As yet another example, a camera may be used to capture image data while a depth sensor is used to capture depth information for the subject.

As shown at block 215, expressive audio by the subject may additionally be captured. In some embodiments, the expressive audio may be captured concurrently with the other sensor data captured at block 210. In some embodiments, the expressive audio may be captured by one or more microphones of a device worn by the subject, such as the device having one or more sensors capturing sensor data at block 210.

The flowchart proceeds to block 220, where the image and/or depth sensor data is converted to geometric information. The geometric information may correspond to a geometry of the subject based on the image and/or depth data. The geometric information may correspond to or encode a geometric shape, such as a 3D mesh, volume, point cloud, or the like. Further, in some embodiments, the geometric information may include a compressed representation of a geometry of the subject from which the geometric shape of the subject can be generated, such as latent values or other encodings.

After capturing the expressive subject sensor data at block 205, the flowchart also proceeds to block 225, where the system extracts characteristics of the subject from the audio. As will be described in greater detail below with respect to FIG. 2B, various techniques can be used to convert the audio data to characteristics. In general, the audio signal captured from a subject can be applied to a mapping algorithm or network which uses one or more techniques to predict characteristics from the audio which may affect a geometry of the subject's face when the audio signal was captured. The resulting characteristics may be generated in the form of a compressed representation of the characteristics, such as latent values or other encodings.

The flowchart 200 concludes at block 230, where a 3D geometric representation of the subject is generated using the first geometric information from block 230 and the extracted characteristics from block 225. The 3D geometric representation of the subject can be generated in a number of ways. In some embodiments, the first geometric information and the extracted characteristics from block 225 can be used in combination to obtain second geometric information, from which the 3D geometric representation is generated. For example, the geometric information from the image and/or depth information at block 220 can be modified in accordance with the extracted characteristics from the audio, as described at block 225. As another example, the extracted characteristics may be provided in a vector representation that is compatible with the first geometric information such that the first geometric information can be concatenated with the extracted characteristics. As another example, the first geometric information and the extracted characteristics can be combined and/or weighted against each other. In some embodiments, the combined or altered geometric information can be applied to a network to generate the 3D geometric representation, which can then be used to render a persona representative of the subject.

Because the 3D geometric representation is generated using visual signals of the expression, such as image or depth, as well as audio signals, the resulting 3D geometric representation may capture characteristics of the subject expression which may not be detectable based on the sensor data captured at 210. For example, characteristics of the face may not be in the field of view capturing the sensor data. Thus, in some embodiments, the 3D geometric representation of the subject generated at block 230 may more accurately reflect a subject's facial expression captured in the expressive image at block 210 than if the 3D geometric representation of the subject was generated without consideration of the expressive audio. As another example, a subject's actual facial gesture may differ from their intended facial gesture due to limitations on the range of motion of the face due to the physical presence of the head mounted device. Thus, in some embodiments, the 3D geometric representation of the subject generated at block 230 may have a greater range of motion than the actual subject, and may more accurately reflect a subject's intended facial expression which may be hindered or otherwise impeded by the head mounted device. As such, in some embodiments, the 3D geometric representation of the subject generated at block 230 may reflect a subject's facial expression in a manner that is different than that captured in the expressive image at block 210, but nevertheless in a manner that more accurately matches an intended expression by inferring additional range of motion than if the 3D geometric representation of the subject was generated without consideration of the expressive audio.

As described above with respect to FIG. 1, according to some embodiments, the extracted characteristics may be encoded in the form of latent variables using one or more encoders. As such, FIG. 2B shows a flowchart of an alternative example technique for using visual and audio data for generating a 3D representation of a subject, according to one or more embodiments. Although the various processes depicted in FIG. 2B are illustrated in a particular order, it should be understood that the various processes described may be performed in a different order. Further, not all of the various processes may be necessary.

The flowchart 250 begins at block 205 where, as described above with respect to FIG. 2A, sensor data is captured of a subject during runtime. Capturing sensor data may include, as shown at block 210, capturing expressive image data and/or depth data of a subject. As described above, the sensor data may be captured by a device worn by the subject, for example by cameras, depth sensors, and the like, configured to capture sensor data of various portions of the subject's face and/or body while the subject is using the device. The sensor data captured at 210 may include data from one or more different types of sensors, and may include one or more different types of sensor data. For example, different sensors may capture characteristics of different parts of a subject's face. As an example, in a head-mounted device, one camera may capture a left eye region of the subject, while another camera may capture a right eye region of the subject. As yet another example, a camera may be used to capture image data while a depth sensor is used to capture depth information for the subject.

As shown at block 215, expressive audio by the subject may additionally be captured. In some embodiments, the expressive audio may be captured concurrently with the other sensor data captured at block 210. In some embodiments, the expressive audio may be collected by one or more microphones. In some embodiments, the expressive audio may be captured by one or more microphones of a device worn by the subject, such as the device having one or more sensors capturing sensor data at block 210.

The flowchart 250 continues at block 255, where the image and/or depth sensor data is converted to geometric latents. According to one or more embodiments, the sensor data may be combined or used to generate a geometric representation of at least part of the face of the subject. The geometric representation may then be applied to an expression encoder trained to generate a compressed representation of the geometry of the subject in the form of geometric latents 112, as described above with respect to FIG. 1.

After capturing the expressive subject sensor data at block 205, the flowchart also proceeds to block 260, where the system converts the audio to audio latents. In some embodiments, the captured audio from block 215 can be applied to an audio encoder to obtain audio latents. For example, an audio autoencoder can be used to generate a compressed representation of the audio.

Optionally, as shown at blocks 265-275, audio classification can be utilized as an alternative to, or in addition to, an audio encoder. At block 265, an audio classification is identified. In some embodiments, the audio signal can be applied to a model which is trained to predict a classification for particular audio. In some embodiments, the classification may include a recognized action associated with the audio or having an associated facial expression, such as a gasp, laugh, sneeze, and the like. Alternatively, the audio classification may be associated with a particular emotion type from which an expression can be determined (e.g., happy, sad, excited, fearful, questioning).

The flowchart 250 continues at block 270, where an expression/emotion is identified as being associated with the audio classification from block 265. In some embodiments, the expression may be associated with a three-dimensional geometric representation of a facial gesture, a modification parameter, degree of motion, and any other form of data suitable for modifying geometric information to better reflect the expression of the subject. The expression may be determined, for example, based on a mapping between the classification and one or more pre-defined expressions, which may be subject-specific in some embodiments.

At block 275, audio latents are identified for the expression. The audio latents may be determined based on predefined audio latents which may or may not be subject-specific. For example, if the expression is a gasp detected in audio, then a set of latents can be identified which are predefined which can be used to generate a three-dimensional representation of the subject performing the gasp.

The flowchart 250 proceeds to block 280, where the geometric latents from block 255 are modified based on the audio latents from block 260. In some embodiments, the audio latents from block 260 may be used to enhance or modify the geometric latents. For example, a quick expression, such as an expression that associated with a sneeze, may be detectable in audio data, but not image data. This may occur, for example, where audio data is capturing data of the subject at a rate more quickly than the image data. In some embodiments, the audio latents are used to modify or enhance the geometric latents. For example, the geometric latents may be weighted in accordance with the audio latents to extend the range of motion captured by the image and/or depth sensor data.

The flowchart 250 concludes at block 285, where a 3D geometric representation of the subject is generated using the modified geometric latents. The 3D geometric representation of the subject can be generated in a number of ways. For example, the modified geometric latents can be applied to a network to generate the 3D geometric representation, which can then be used to render a persona representative of the subject.

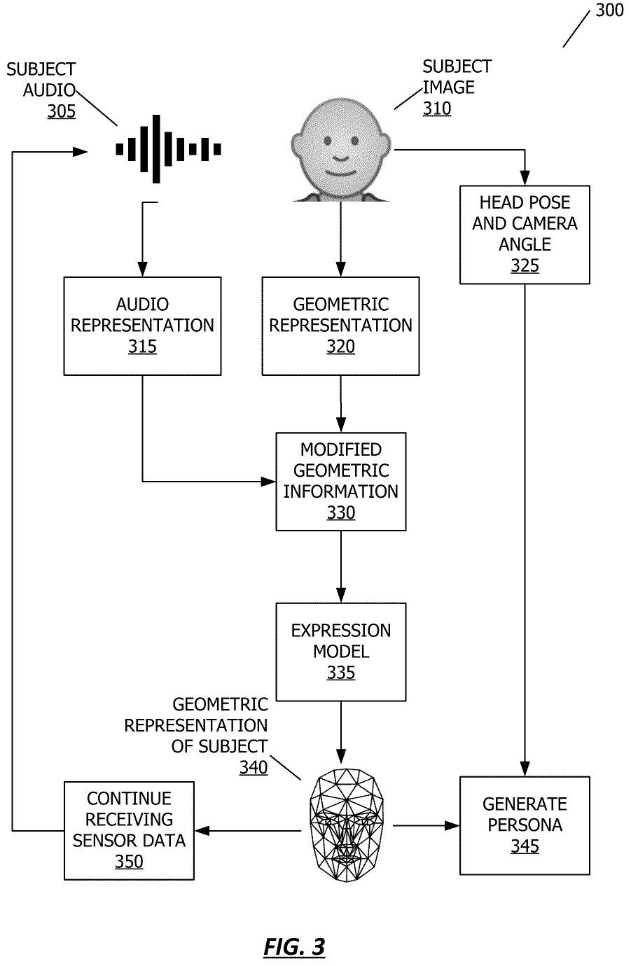

FIG. 3 shows, in flow diagram form, a technique for generating a geometric representation of a subject during runtime, according to one or more embodiments. In particular, FIG. 3 shows an example flow for continuously updating a persona using a geometric representation of a subject based on audio and visual data, in accordance with one or more embodiments. The persona may be rendered on the fly, and may be rendered, for example, as part of a gaming environment, an extended reality application, a communication session, and the like. The example flow is presented merely for description purposes. In one or more embodiments, not all components detailed may be necessary, and in one or more embodiments additional or alternative components may be utilized.

The flowchart collects subject audio 305 and subject image 310. The subject may be a person or other entity for which a virtual representation is to be generated, for example in the form of a persona. The subject audio 305 and the subject image 310 may be collected as a subject is speaking, and the subject audio 305 and the subject image 310 is captured to generate the persona representative of the subject's movements captured in the subject audio 305 and the subject image 310. According to one or more embodiments, the subject audio 305 and the subject image 310 may be collected at the same or different rates, and may be collected by sensors on the same or different device.

Upon receiving the subject image 310 and/or other sensor data such as depth data, the system can determine geometric representation 320 associated with the subject image 310. In some embodiments, the system can perform a latent vector lookup based on the image. For example, the geometric information may be in the form of latent values. A latent vector including the latent values may be obtained from an expression model which maps image data and/or depth data to 3D geometric information for a representation of the subject in the image and/or depth data. As described above, the latents may represent the offset from the geometric information for a neutral expression, and/or may be determined from an expression encoder which has been trained to produce a compact representation of the geometry in the image and/or depth data. In some embodiments, an initial step may be performed to generate a geometric representation of the subject using the subject image 310, such as in the form of a 3D mesh, point cloud, volume representation, or the like. The geometric representation may then be applied to an encoder configured to generate latent values from the geometric representation.

Similarly, upon receiving the subject audio 305, the system can determine an audio representation 315, such as audio latents that includes an emotion of the subject, which can be used to modify geometric information associated with the subject. In some embodiments, the system can perform a latent vector lookup based on the audio. For example, the subject audio 305 can be applied to a mapping algorithm which uses one or more techniques to predict representations of characteristics present in the audio. In some embodiments, the characteristics may include a compressed representation of audio features that may affect a geometry of the subject, such as latent values or other encodings. In some embodiments, the audio representation 315 may be based on audio corresponding to a particular captured frame from subject image 310, or may be based on a longer window of audio data.

Modified geometric information 330 is generated from the audio representation 315 and the geometric representation 320. According to some embodiments, the geometric representation 320 from the image and/or depth information can be modified in accordance with the audio representation 315. As another example, the audio representation 315 and the geometric representation 320 can be combined and/or weighted against each other to obtain the modified geometric information 330.

According to one or more embodiments, the modified geometric information 330 may be represented in the form of input values which can be applied to a network or trained model, such as expression model 335 to generate a geometric representation of subject 340. Accordingly, the 3D geometric representation of subject 340 is generated using first geometric information from the geometric representation 320, and audio representation 315, derived from subject audio 305. In some embodiments, the modified geometric information may be in the form of latent values, and the expression model 335 may be a decoder configured to generate a geometric representation of the subject based on the ingested latent values from the modified geometric information 330. In some embodiments, the subject audio 305 and the subject image 310 may be captured at different rates. Accordingly, the modified geometric information 330 may be based on a longer amount of audio data than what is captured for a particular frame.

Additionally, in some embodiments, a head pose and camera angle 325 may be determined from the subject image 310. According to some embodiments, the system determines a head pose and camera angle (for example a view vector) in determining an expression to be represented by the persona. According to one or more embodiments, the head pose may be obtained based on data received sensors on a device worn by the subject, such as a camera or depth sensor, or other sensors that are part of or communicably coupled to a client device.

At block 345, the persona is generated using the geometric representation of the subject 340 and the head pose and camera angle 325. The persona may be rendered in a number of ways. As an example, a texture may be overlaid over a geometric representative of the subject presenting the particular expression. The texture may be rendered as an additional pass in a multipass rendering technique. As another example, additional treatments can be applied, such as lighting, opacity, and the like.

Because the geometric representation of subject 340 is generated in real time, the geometric shape of the subject will change over time as the subject moves. As such, at block 350, the system continues to receive sensor data of the subject, including audio data and image/depth data. Then the flowchart repeats at 305 and 310 while new image data and audio data is continuously received.

In some embodiments, multiple client devices may be interacting with each other in a communication session. Each client device may generate avatar data representing users of the other client devices. A recipient device may receive, for example, the modified geometric information 330, or the geometric representation of subject 340, from which the persona generated at block 345 is rendered on the recipient device. In some embodiments, the recipient device may receive the expression model 335 only once, or less frequently than the modified geometric information 330, and can use the compressed representation of the modified geometric information to generate the geometric representation of subject 340, thereby reducing the amount of data that must be transmitted between devices.

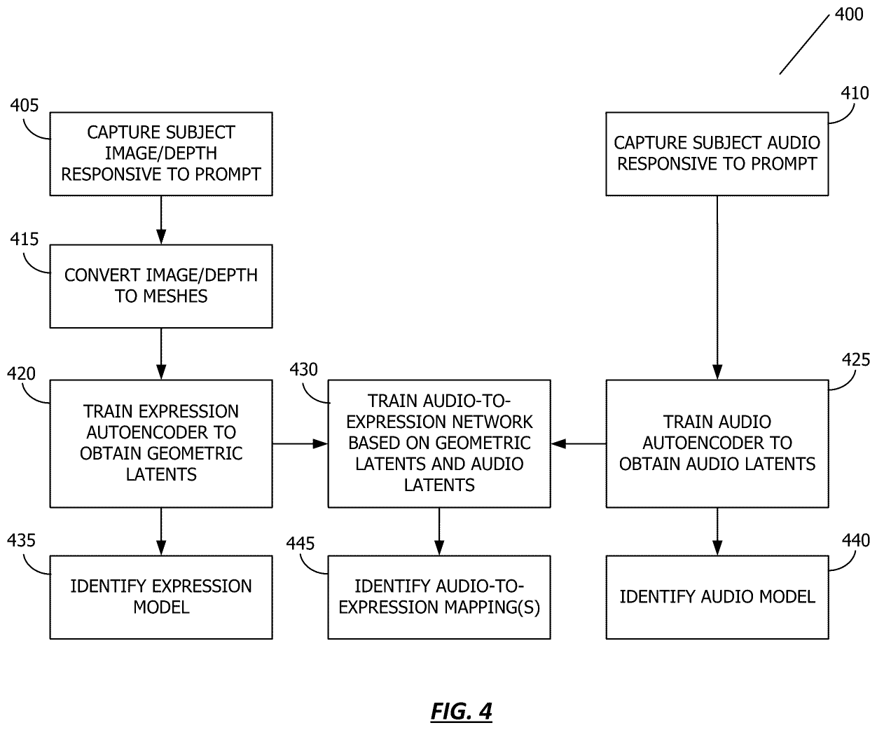

FIG. 4 shows, in flowchart form, an enrollment technique, in accordance with one or more embodiments. The example flow is presented merely for description purposes. In one or more embodiments, not all components detailed may be necessary, and in one or more embodiments additional or alternative components may be utilized.

The flowchart 400 begins at 405, where a training module captures or otherwise obtains expression images responsive to one or more user prompts presented by the system. In one or more embodiments, the expression images may be captured as a series of frames, such as a video, or may be captured from still images or the like. The expression images may be acquired from numerous individuals, or a single individual. By way of example, images may be obtained via a photogrammetry or stereophotogrammetry system, a laser scanner, or an equivalent capture method. Alternatively, the expression images may be captured by one or more cameras and/or other sensors on a user device, such as a head mounted device. In some embodiments, different sensors will be used during enrollment than at runtime. For example, in some embodiments, a user may hold the device in front of them during the enrollment process and capture image data using outside-facing cameras, whereas user-facing cameras capture an image of the user during runtime. To that end, the facial gestures captured during enrollment may not be encumbered by the device the same way as facial gestures captured during runtime are.

Once the images and/or depth information are captured, the flowchart continues at 415, where a training module converts the image and/or depth information to 3D meshes or other 3D geometric representations. The 3D mesh represents a geometric representation of the geometry of the subject's face and/or head when the subject is performing the expression, according to one or more embodiments. In some embodiments, the system using a network or other model trained to translate the image data to a 3D representation of the geometry of the subject.

Once 3D meshes are obtained from the expression images, the flowchart may continue to block 420, where the 3D mesh representation may be used to train an expression autoencoder. The expression autoencoder may be trained to reproduce a given expression mesh. As part of the training process of the expression mesh autoencoder, geometric latents may be obtained as a compact representation of a unique mesh. The geometric latents may refer to latent vector values representative of the particular subject expression in the image. Particularly, the geometric latent vector is a code that describes to a decoder how to deform a mesh to fit a particular subject geometry for a given expression. At 435, the training module can identify an expression model. According to one or more embodiments, the expression model may be trained to predict a particular geometry of the subject's face in an expressive state. Optionally, in one or more embodiments, conditional variables may be applied to the expression model to further refine the model's output. Illustrative conditional variables include, for example, gender, age, and body mass index, as well as emotional state or other parameters, for example those determined from audio. In one or more embodiments, the specific subject's expression model may be stored for use during runtime.

In addition to capturing subject image/depth, at block 410, subject audio is also captured responsive to the user prompts presented by the system. The subject audio may be captured concurrently with the image/depth information from block 405. Further, the subject audio may be captured from one or more microphones on the same system as the cameras or other sensors used at block 405, or from a different system.

The flowchart 400 continues at 425, where the subject audio is used to train an audio autoencoder. The audio autoencoder may be trained to reproduce a given expressive audio signal. As part of the training process of the audio autoencoder, the audio autoencoder may produce audio latents corresponding to a condensed representation of the ingested audio. The geometric latents may refer to latent vector values representative of the particular subject expression in the image. Particularly, the mesh latent vector is a code that describes to a decoder how to deform a mesh to fit a particular subject geometry for a given expression. At 440, the training module can identify an audio model. According to one or more embodiments, the audio model may be trained to classify a particular audio received from a subject, for example to a particular emotional state, subject reaction, or the like. In some embodiments, the audio model 440 may be stored for use during runtime.

At block 430, an audio-to-expression network is trained based on the geometric latents and audio latents. According to one or more embodiments, the audio-to-expression network determines correspondences between the geometric data from the image/depth data captured at block 405 and/or the resulting meshes generated at block 415. At 445, the training module can identify audio-to-expression mappings. According to one or more embodiments, the audio-to-expression mappings can include a model, a mapping, parameters, or the like, which can be used to modify geometric data determined from the image/depth data based on audio signals to identify and/or generate facial expression characteristics which may be lost or undetectable during runtime. In some embodiments, the audio-to-expression mapping(s) identified at block 445 may be stored for use during runtime.

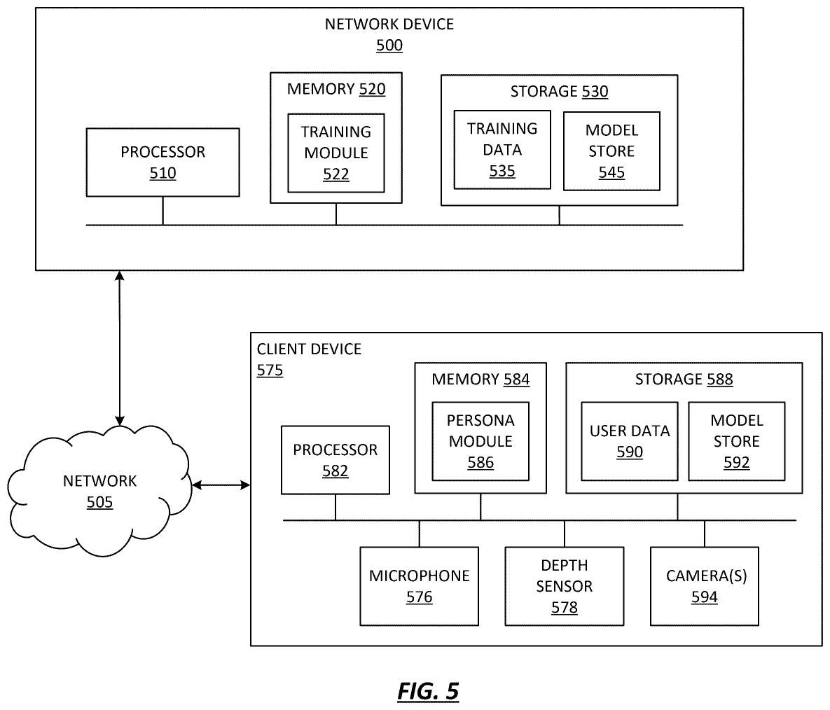

Referring to FIG. 5, a simplified block diagram of a network device 500 is depicted, communicably connected to a client device 575, in accordance with one or more embodiments of the disclosure. Client device 575 may be part of a multifunctional device, such as a mobile phone, tablet computer, personal digital assistant, portable music/video player, wearable device, base station, laptop computer, desktop computer, network device, or any other electronic device. Network device 500 may represent one or more server devices or other network computing devices within which the various functionality may be contained, or across which the various functionality may be distributed. Network device 500 may be connected to the client device 575 across a network 505. Illustrative networks include, but are not limited to, a local network such as a universal serial bus (USB) network, an organization's local area network, and a wide area network such as the Internet. According to one or more embodiments, network device 500 is utilized to train one or more models for generating geometric information of a subject from image and audio data. Client device 575 is generally used to generate and/or present a persona which is rendered in part based on image and audio data captured of a subject. It should be understood that the various components and functionality within network device 500 and client device 575 may be differently distributed across the devices, or may be distributed across additional devices.

Network device 500 may include a processor 510, such as a central processing unit (CPU). Processor 510 may be a system-on-chip such as those found in mobile devices and include one or more dedicated graphics processing units (GPUs). Further processor 510 may include multiple processors of the same or different type. Network Device 500 may also include a memory 520. Memory 520 may each include one or more different types of memory, which may be used for performing device functions in conjunction with processor 510. For example, memory 520 may include cache, ROM, RAM, or any kind of transitory or non-transitory computer readable storage medium capable of storing computer readable code. Memory 520 may store various programming modules for execution by processor 510, including training module 522. Network device 500 may also include storage 530. Storage 530 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Storage 530 may include training data 535 and model store 545.

Client device 575 may be electronic devices with components similar to those described above with respect to network device 500. Client device 575 may include, for example, a memory 584 and processor 582. Client device 575 may also include one or more camera(s) 594 or other sensors, such as depth sensor 578, from which depth of a scene may be determined. In one or more embodiments, each of the one or more cameras 594 may be a traditional RGB camera or a depth camera. Further, camera(s) 594 may include a stereo- or other multi-camera system, a time-of-flight camera system, or the like which capture images from which depth information of a scene may be determined. In addition, cameras 594 may include a user-facing camera, a scene camera such as a front facing camera, or some combination thereof. Client device 575 may allow a user to interact with computer-generated reality (CGR) environments, such as extended reality (XR) environments.

According to one or more embodiments, training module 522 may train an expression model, such as an expression autoencoder neural network, based on image data from a single subject or multiple subjects. Further, training module 522 may train an audio model, an expression model, and/or an audio-to-expression mapping, based on image data and audio data captured of a subject during an enrollment process, for example in response to user prompts. The audio may be captured, for example by one or more microphones of the client device 575, such as microphone 576. Although the training module 522 is presented as a module hosted by the network device 500, in some embodiments, the training module 522 may be hosted by the client device 575, such as in user data 590 and/or model store 594 of storage 588.

In some embodiments, the client device 575 may capture image data of a person or people presenting one or more facial expressions while repeating or responding to predefined prompts. In one or more embodiments, the image data may be in the form of still images, or video images, such as a series of frames. As a more specific example, the network device may capture ten minutes of data of someone with different facial expressions at 60 frames per second, although various frame rates and lengths of video may be used. According to one or more embodiments, an expression decoder may be obtained, which may translate expression latent values into a geometric shape. Similarly, an audio autoencoder and/or audio mappings can be generated based on received audio data to determine correspondences between audio data and subject expression in the form of facial geometry.

Returning to client device 575, persona module 586 renders a persona or other virtual representation of a subject such as an avatar, for example, depicting a user of client device 575 or a user of a device communicating with client device 575. In one or more embodiments, the persona module 586 renders the persona based on information such as head pose and camera angle, along with a latent representation of a geometry of the expression, and a latent representation of the audio captured from the subject.

Although network device 500 is depicted as comprising the numerous components described above, in one or more embodiments, the various components may be distributed across multiple devices. Particularly, in one or more embodiments, one or more of the training module 522 and persona module 586 may be distributed differently across the network device 500 and the client device 575, or the functionality of either of the training module 522 and persona module 586 may be distributed across multiple modules, components, or devices, such as network devices. Accordingly, although certain calls and transmissions are described herein with respect to the particular systems as depicted, in one or more embodiments, the various calls and transmissions may be made differently directed based on the differently distributed functionality. Further, additional components may be used, some combination of the functionality of any of the components may be combined.

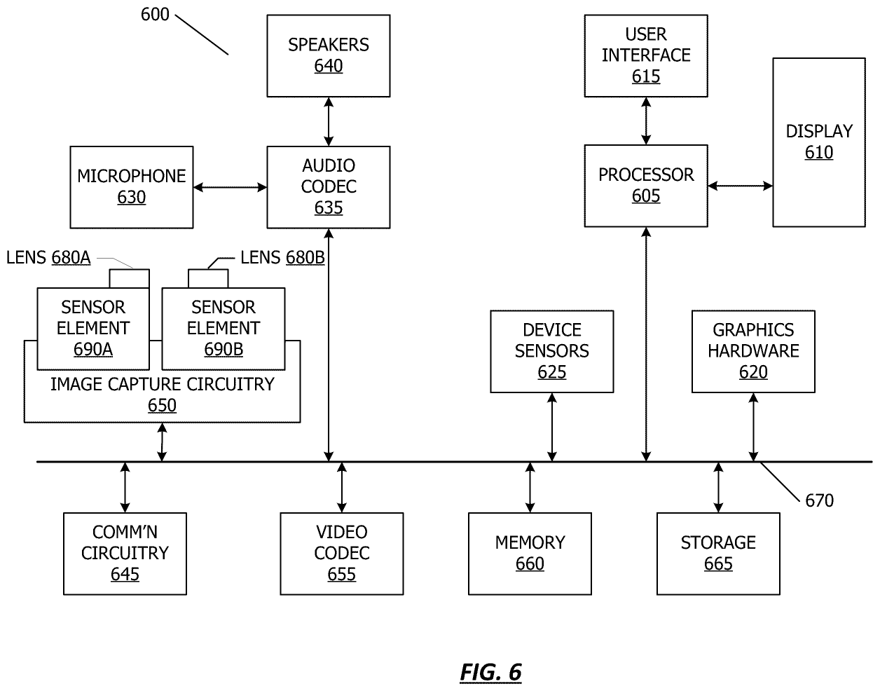

Referring now to FIG. 6, a simplified functional block diagram of illustrative multifunction electronic device 600 is shown according to one embodiment. Each electronic device may be a multifunctional electronic device, or may have some or all of the described components of a multifunctional electronic device described herein. Multifunction electronic device 600 may include processor 605, display 610, user interface 615, graphics hardware 620, device sensors 625 (e.g., proximity sensor/ambient light sensor, accelerometer, and/or gyroscope), microphone 630, audio codec(s) 635, speaker(s) 640, communications circuitry 645, digital image capture circuitry 650 (e.g., including camera system), video codec(s) 655 (e.g., in support of digital image capture unit), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed, at least in part, by video codec(s) 655 and/or processor 605 and/or graphics hardware 620, and/or a dedicated image processing unit or pipeline incorporated within image capture circuitry 650. Images so captured may be stored in memory 660 and/or storage 665.

Image capture circuitry 650 may capture still and video images that may be processed in accordance with this disclosure, at least in part, by video codec(s) 655 and/or processor 605 and/or graphics hardware 620, and/or a dedicated image processing unit incorporated within image capture circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image, and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605 such computer program code may implement one or more of the methods described herein.

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology is the gathering and use of data available from various sources to estimate facial gestures from an image of a face and audio collected from a subject. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, and exercise information), date of birth, or any other identifying or personal information.

The present disclosure recognizes that the use of such personal information data, in the present technology, can be used to the benefit of users. For example, the personal information data can be used to train expression models. Accordingly, use of such personal information data enables users to estimate emotion from an image of a face. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIP4); whereas health data in other countries may be subject to other regulations and policies and should be handled accordingly. Hence different privacy practices should be maintained for different personal data types in each country.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions or the arrangement of elements shown should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A non-transitory computer readable medium comprising computer readable code executable by one or more processors to:
capture, for each of a plurality of frames, an image and audio of a subject;
determine, based on the image, first geometric data representing a geometry of the subject;
determine, based on the audio, a characteristic of the subject;
determine second geometric data based on the first geometric data and the characteristic of the subject, wherein the second geometric data is different from the first geometric data; and
generate a 3D representation of the subject using the second geometric data.

2. The non-transitory computer readable medium of claim 1, wherein the computer readable code to determine the first geometric data comprises computer readable code to:
convert the image to geometric latents.

3. The non-transitory computer readable medium of claim 2, wherein the computer readable code to determine the first geometric data comprises computer readable code to:
apply image data from the image to an expression encoder from an expression autoencoder.

4. The non-transitory computer readable medium of claim 3, wherein the computer readable code to determine the first geometric data comprises computer readable code to:
apply depth data to the expression encoder.

5. The non-transitory computer readable medium of claim 1, wherein the computer readable code to determine the second geometric data comprises computer readable code to:
convert the audio into audio latents.

6. The non-transitory computer readable medium of claim 5, wherein the computer readable code to convert the audio into audio latents comprises computer readable code to:
apply the audio to an audio encoder from an audio autoencoder.

7. The non-transitory computer readable medium of claim 5, wherein the computer readable code to determine the second geometric data comprises computer readable code to:
obtain an audio classification for the audio;
determine a facial expression associated with the audio classification; and
identify the audio latents associated with the facial expression.

8. A method comprising:
capturing, for each of a plurality of frames, an image and audio of a subject;
determining, based on the image, first geometric data representing a geometry of the subject;
determining, based on the audio, a characteristics of the subject;
determining second geometric data based on the first geometric data and the characteristic of the subject, wherein the second geometric data is different from the first geometric data; and
generating a 3D geometric representation of the subject using the second geometric data.

9. The method of claim 8, wherein determining the first geometric data comprises:
converting the image to geometric latents.

10. The method of claim 9, wherein determining the first geometric data:
applying image data from the image to an expression encoder from an expression autoencoder.

11. The method of claim 10, wherein determining the first geometric data comprises:
applying depth data to the expression encoder.

12. The method of claim 8, wherein determining the second geometric data comprises:
converting the audio into audio latents.

13. The method of claim 12, wherein converting the audio into audio latents comprises:
applying the audio to an audio encoder from an audio autoencoder.

14. The method of claim 12, wherein determining the second geometric data comprises:
obtaining an audio classification for the audio;
determining a facial expression associated with the audio classification; and
identifying the audio latents associated with the facial expression.

15. A system comprising:
one or more processors; and
one or more computer readable media comprising computer readable code executable by the one or more processors to:
capture, for each of a plurality of frames, an image and audio of a subject;
determine, based on the image, first geometric data representing a geometry of the subject;
determine, based on the audio, a characteristic of the subject;
determine second geometric data based on the first geometric data and the characteristic of the subject, wherein the second geometric data is different from the first geometric data; and
generate a 3D geometric representation of the subject using the second geometric data.

16. The system of claim 15, wherein the computer readable code to determine the first geometric data comprises computer readable code to:
convert the image to geometric latents.

17. The system of claim 16, wherein the computer readable code to determine the first geometric data comprises computer readable code to:
apply image data from the image to an expression encoder from an expression autoencoder.

18. The system of claim 17, wherein the computer readable code to determine the first geometric data comprises computer readable code to:
apply depth data to the expression encoder.

19. The system of claim 15, wherein the computer readable code to determine the second geometric data comprises computer readable code to:
convert the audio into audio latents.

20. The system of claim 19, wherein the computer readable code to convert the audio into audio latents comprises computer readable code to:
apply the audio to an audio encoder from an audio autoencoder.
